(19) United States
(12) Patent Application Publication
(10) Pub. No.: US 2004/0020383 A1
(43) Pub. Date: Feb. 5, 2004

(54) Printing group of an offset rotary printing machine

(76) Inventor: Jurgen Alfred Stiel, Thungen (DE)

Correspondence Address: Douglas R Hanscom, Jones Tullar & Cooper, P O Box 2266, Eads Station, Arlington, VA, 22202, US

(21) Appl. No.: 10/312,597

(22) PCT Filed: Mar. 30, 2001
(86) PCT No.: PCT/DE01/01215

(30) Foreign Application Priority Data
Jul. 22, 2000 (DE) 100 35 785.7

(51) Int. Cl. B41F 5/16

(52) U.S. Cl. 101/180

(57) ABSTRACT

A printing group of an offset rotary printing machine includes at least one forme cylinder, one transfer cylinder and at least one inking system. Two of these printing groups are arranged opposite to each other. The arrangement of the printing group in relation to each other can be arranged in an axial direction which is parallel to the axes of rotation of the cylinders.

The invention relates to a printing group of an offset rotary printing press in accordance with the preamble of claim 1 or 2.

A print unit for a multi-color web-fed rotary printing press for sheet work is known from EP 0 749 369 B1, wherein two printing groups are arranged by means of a so-called bridge construction opposite each other in a frame, wherein the arrangement of the printing groups relative to each other can be changed transversely to the direction of the axes of rotation of the cylinders.

An offset printing press known from DE 198 33 468 A1 also has respectively two oppositely located print, which can be arranged, separated along a vertical plane of separation, and their distance from each other can be changed.

A web-fed rotary printing press is described in EP 0 958 917 A1, which has several printing groups, each consisting of two printing groups. In this case the printing groups are arranged on top of each other and can be separated along a substantially horizontally extending plane of separation. The individual printing groups can be displaced vertically transversely in respect to the axes of rotation of the cylinders, so that a distance can be provided between the individual printing groups, for example for maintenance work.

A web-fed rotary printing press is known from EP 0 638 419 B1, whose individual components, in particular the cylinder elements and their associated ink and dampening units, are seated in a support frame. In this case the ink and dampening units are embodied as displaceable units, which can be pulled out of the printing group in an axis-parallel direction of the axes of rotation.

DE 199 19 864 C1 discloses two five-cylinder print units, which can be displaced relative to each other either transversely to or along the axis of rotation of the cylinders.

The object of the invention is based on providing a printing group for an offset rotary printing press.

In accordance with the invention, this object is attained in accordance with the characteristics of claim 1 or 2.

The advantages to be gained by means of the invention primarily lie in that the required space in front of and behind each of the printing groups, which are respectively arranged in pairs, can be reduced. For performing maintenance work it is not required to move the printing groups away from each other transversely in relation to the axes of rotation of the cylinder, as known from the prior art. Instead, the printing groups are arranged laterally offset in an axis-parallel direction of the axes of rotation of the cylinders, so that the printing groups become accessible for the required work without the distance between the printing groups transversely to the direction of the axes of rotation of the cylinders needing to be changed. This measure is advantageous especially in those cases where several printing groups, which are arranged in pairs, are arranged one behind the other, for example in the form of printing towers arranged one behind the other, since in this case it is possible to place the pairs of printing groups, which are arranged one behind the other, at reduced distances from each other. A further advantage ensues from the fact that certain parts of the printing groups, namely the parts which are located the farthest toward the outside on a side of a printing group, are fully accessible already with a relatively small lateral offset between the printing groups. By means of this it becomes possible, for example, to arrange parts of the printing groups which are particularly maintenance-intensive in this area of the printing groups, so that for inspection or maintenance of these maintenance-intensive parts of the printing groups it is not necessary to move them completely apart from each other, but only far enough so that the parts to be maintained are sufficiently accessible.

Since not only individual units consisting of ink and dampening units can be pulled laterally out of the printing groups, but instead the entire oppositely-located printing groups can be arranged laterally offset, it is possible in particular to perform maintenance work on substantially all parts of the printing groups without further steps for opening the printing groups becoming substantially necessary.

It is basically sufficient if, for separating the printing groups which are located opposite each other, these can be arranged laterally offset in relation to each other in an axis-parallel direction of the axes of rotation of the cylinders. However, it is particularly advantageous if in addition the printing groups can be arranged so that their distance in relation to each other can be at least slightly changed. In the course of moving a printing group consisting of two oppositely-located printing groups apart, it is then possible, for example, to first displace the one printing group in a direction transversely to the axes of rotation of the cylinders until at least a slight distance between the printing groups has been created. By means of this movement transversely to the direction of the axes of rotation of the cylinders it is possible to bring the printing groups initially out of engagement with each other. It is thereafter possible to displace the printing group in an axis-parallel direction to the axes of rotation of the cylinders in order to make the parts located in the interior of the printing group accessible.

Advantageous embodiments ensue from the combination of characteristics of the invention with characteristics already known from the prior art. Characteristics, whose combination into an arrangement of printing groups in accordance with the invention is particularly advantageous, are known from EP 0 749 369 B1 and DE 198 33 468 A1.

Exemplary embodiments of the invention are represented in the drawings and will be described in greater detail in what follows.

Shown are in:

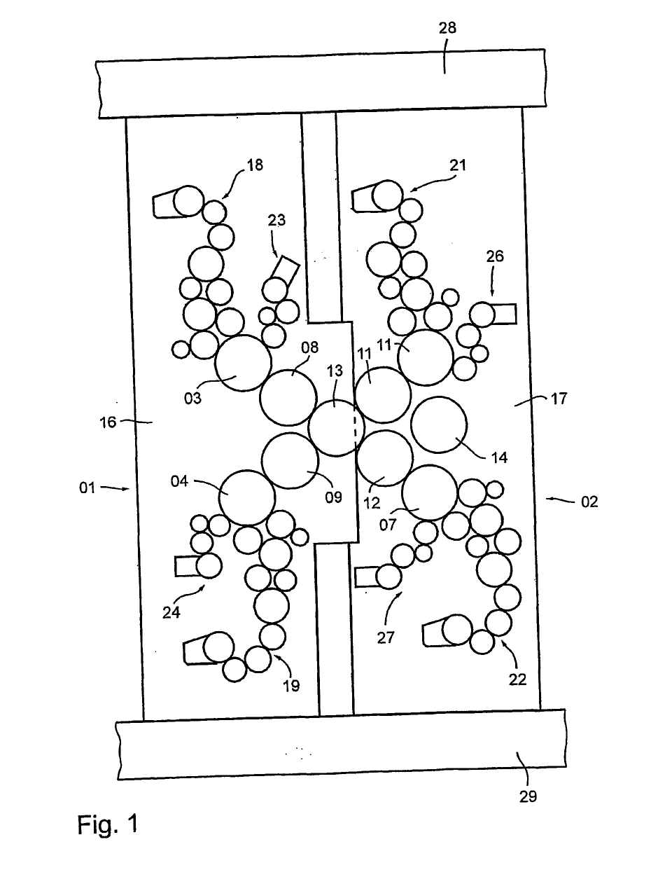

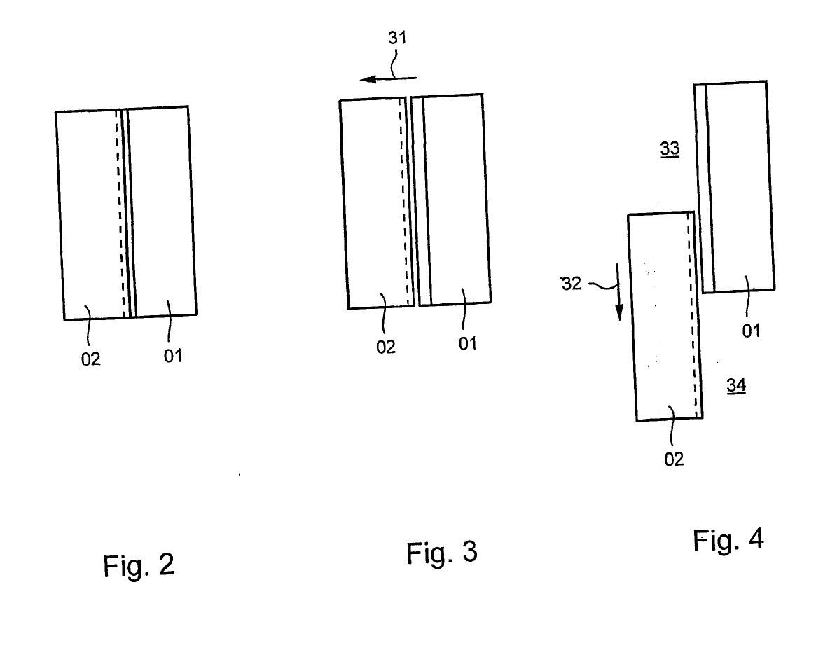

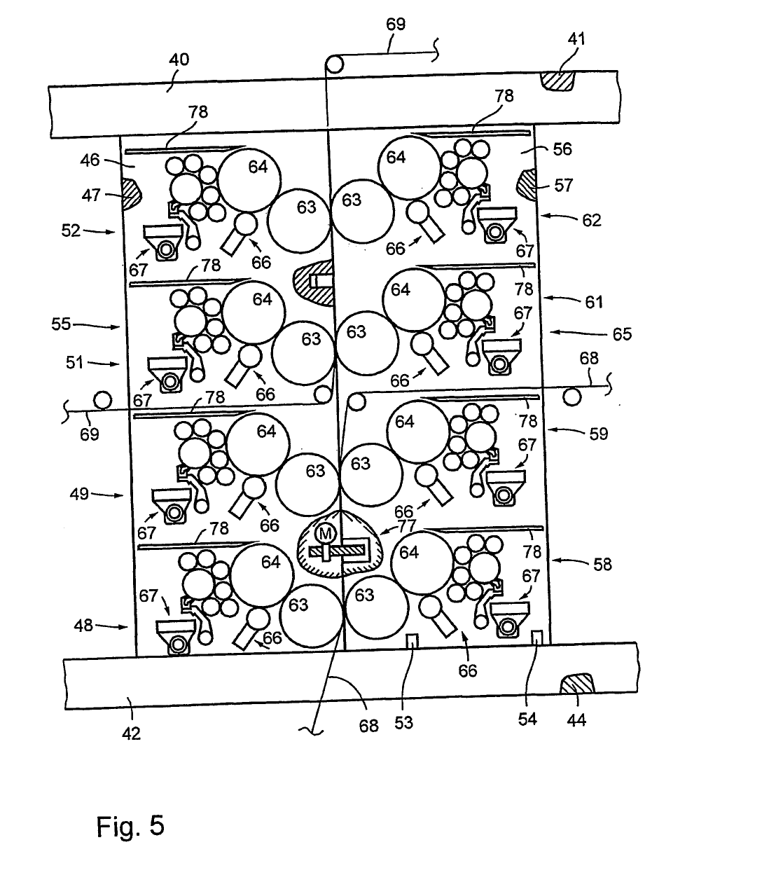

FIG. 1, the arrangement of a first embodiment of printing groups in lateral cross section, FIG. 2, a schematic representation of the arrangement of printing groups in accordance with FIG. 1 in the operational state in a plan view from above, FIG. 3, a schematic representation of the arrangement of printing groups in accordance with FIG. 1 when the print groups are separated in a plan view from above, FIG. 4, a schematic representation of the arrangement of printing groups in accordance with FIG. 1 when the print groups are opened in a plan view from above, FIG. 5, the arrangement of a second embodiment of printing groups in lateral cross section,

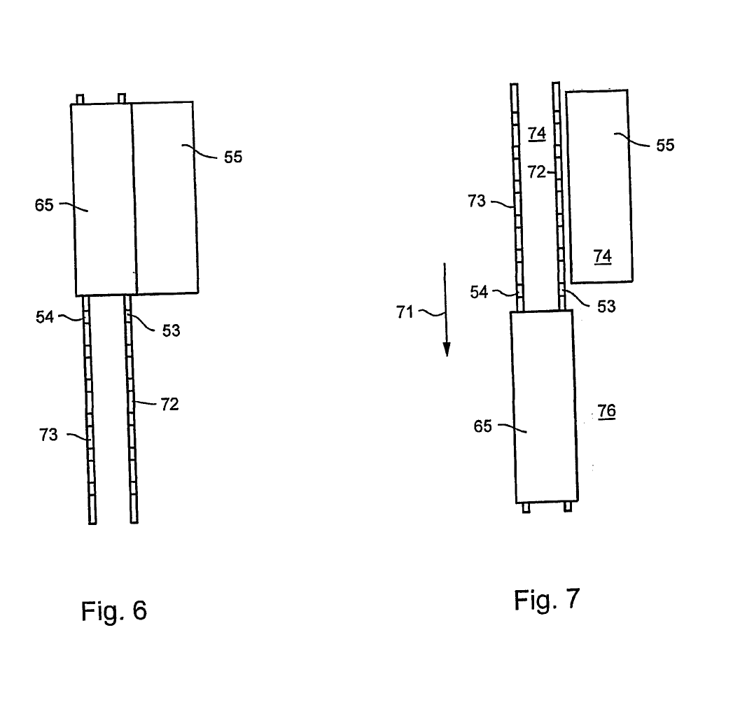

FIG. 6, a schematic representation of the arrangement of printing groups in accordance with FIG. 5 in the operational state in a plan view from above, FIG. 7, a schematic representation of the arrangement of printing groups in accordance with FIG. 5 in the opened state in a plan view from above.

An offset rotary printing press, or a section of an offset rotary printing press, has for example eight printing groups in a modular construction, of which only the printing groups 01, 02 are represented in FIG. 1. The construction of the individual printing groups 01, 02 corresponds in the essential characteristics to the construction described in DE 198 33 468 A1.

Each one of these printing groups 01, 02 is embodied as a so-called 5-cylinder printing group, and each has substantially two forme cylinders 03, 04, 06, 07, for example plate cylinders, two transfer cylinders 08, 09, 11, 12, for example rubber blanket cylinders, and one counter-pressure cylinder 13, 14, for example a satellite cylinder. The journals of these cylinders 03, 04, 06, 07, 08, 09, 11, 12, 13, 14 are seated in respective lateral frames 16, 17 on each side of the offset rotary printing press. In the present exemplary embodiment, the journals of the transfer cylinders 08, 09, 11, 12 are pivotably seated in eccentric bushings or in accordance with three-ring bearing technology, so that the transfer cylinders 08, 09, 11, 12 can be placed against and away from the associated counter-pressure cylinders 13, 14. It is also possible to place the counter-pressure cylinders 13, 14 against the associated transfer cylinders 08, 09, 11, 12, for example by means of eccentric bushings, three-ring bearings or by linear guidance.

In the present exemplary embodiment, each cylinder 03, 04, 06, 07, 08, 09, 11, 12, 13, 14 is provided with its own, rpm-controlled and/or position-controlled drive motor. However, it is also possible to assign a drive motor to each pair of forme and transfer cylinders 03, 08, 04, 09, 06, 11, 07, 12, and to positively couple this pair. In this case the counter-pressure cylinder 13, 14 also has its own drive motor, or it can be coupled to one of the pairs of forme or transfer cylinders 03, 08, 04, 09, 06, 11, 07, 12. It is also possible to assign only one drive motor to each printing couple 01, 02 and to transmit the drive moment to be transferred by means of a vertical shaft, for example. Independently of the type of drive mechanism it is possible to arrange a coupling between one or several cylinders and each of the associated drive mechanisms, so that each individual cylinder or cylinder group can be separately switched in. In any case, the drive motors are fixedly assigned to each one of a lateral frame 16, 17, independently of the position and installation location of the printing groups 01, 02, so that in the printing group 02, which is placed pivoted by 180° around a vertical line, the drive motors are arranged on the opposite side of the printing press. Respectively one ink unit 18, 19, 22, 22, and one dampening unit 23, 24, 26, 27 is assigned to the forme cylinders 03, 04, 06, 07. In the embodiment represented, the printing group 01 is embodied as a V-printing group 01, for example, and the printing group 02 as a W-printing group 02, for example. The printing groups 01, 02 can each be operated independently of each other as five-cylinder printing groups located opposite each other, i.e. in a first mode of operation two oppositely located printing groups functionally constitute a ten-cylinder satellite printing group. During this first operating state, the transfer cylinders 08, 09, 11, 12 interact with the respective counter-pressure cylinder 13, 14 of the V-printing group 0l and the W-printing group 02. In a second operating state two five-cylinder printing groups functionally act as a nine-cylinder satellite printing group. This operating state is represented in FIG. 1. For this purpose, the transfer cylinders 08, 09, 11, 12 of the V-printing group 01 and of the W-printing group 02 can be placed against and away from the counter-pressure cylinder 13 of the V-printing group 01. In this operating state, the counter-pressure cylinder 14 of the W-printing group 02 is not part of the printing process.

The printing groups 01, 02 are fastened in a support element, of which only the transverse supports 28, 29 have been schematically represented in FIG. 1. In this case the V-printing group 01 is connected, fixed in place, with the transverse supports 28, 29, while the W-printing group 02 is displaceably seated in the support element. The printing group 01, 02 formed from the printing group 01, 02 can be opened by the operators, in particular for servicing and maintenance. The required actuating movements for opening the printing group 01, 02 formed from the printing group 01, 02 are schematically indicated in FIGS. 2 to 4.

In FIGS. 2 to 4, the printing groups 01, 02 have only been schematically represented, with the surrounding support elements left out. In FIG. 2, the printing groups 01, 02 are represented in a plan view from above in the operating state corresponding to the operating state in FIG. 1. The movably seated printing group 02 is locked together with the fixedly seated printing group 01, so that the printing groups 01, 02 together constitute a fixed-in-place printing group 01, 02. For opening the printing group 01, 02, the printing groups 01, 02 are first separated, as represented in FIG. 3, in that the printing group 02 is displaced during an actuating movement indicated by the movement arrow 28 in a direction transversely to the axes of rotation of the cylinders 03, 04, 06, 07, 08, 09, 11, 12, 13, 14. A distance between the printing groups 01, 02 is created by this, so that the printing groups 01, 02 are no longer in engagement with each other. Subsequently the printing group 02 is displaced toward the side during an actuating movement indicated by the movement arrow 32 in a direction axis-parallel with the axes of rotation of the cylinders 03, 04, 06, 07, 08, 09, 11, 12, 13, 14, as represented in FIG. 04, so that, depending on the lateral offset between the printing groups 01, 02, increasingly larger areas of the interior of the printing groups 01, 02 become accessible for servicing and maintenance work. In the process the printing group 02 can be displaced outward, i.e. in the exemplary embodiment represented toward the front, to such an extent, that the printing groups 01, 02 are no longer located opposite each other, so that all areas of the interior of the printing groups 01, 02 are accessible from work platforms arranged in the areas 33, 34. For closing the printing group 01, 02 constituted by the printing groups 01, 02, the printing group 02 is displaced in a reversed sequence and is finally locked to the printing group 01.

FIG. 5 shows a second embodiment of an arrangement of printing groups 48, 49, 51, 52,58, 59, 61, 62. The upper support 40, 41, as well as the lower support 42, 44 of a multi-color web-fed rotary printing press receives several printing groups 48, 49, 51, 52,58, 59, 61, 62, which are fixed on the supports and arranged on top of each other, in a left frame element 55 formed on the lateral frames 46, 47. The printing groups 48, 49, 51, 52 seated in the left frame element 55 are seated fixed in place and will be called the printing group 48, 49, 51, 52 in what follows. Furthermore, a right frame element 65, which is displaceable on rollers 53, 54 and is formed by the lateral frames 56, 57, is arranged between the supports 40, 41, 42, 44. The right printing groups 58, 59, 61, 62 are arranged opposite the left printing groups 48, 49, 51, 52 in the lateral frames 56, 57.

In its essential characteristics the construction of the individual printing groups 48, 49, 51, 52 and 58, 59, 61, 62, and the printing groups formed thereof corresponds to the construction described in EP 0 749 369 B1. Each printing group 48, 49, 51, 52 and 58, 59, 61, 62 respectively consists of a transfer cylinder 63, for example a rubber blanket cylinder, which interacts with a forme cylinder 64, for example a plate cylinder. The forme cylinder 64 is provided with a dampening agent by a dampening unit 66 and with ink by an ink unit 67. The ink unit 67 can for example consist of an ink trough with an ink roller, wherein the ink roller transfers its printing ink to the forme cylinder 64 by means of ink application rollers. In place of two ink application rollers it is also possible to use only one smaller or larger ink application roller. It is also possible, for example, to use a chamber doctor blade in connection with a screen roller (anilox roller), for example, in place of an ink trough, as well as an ink application roller. However, a conventional ink unit can also be employed.

Each dampening unit 66 can be embodied as a spray dampening unit consisting of a known spray device, for example a strip with spray nozzles, whose sprays are directed on a dampening agent application roller. This dampening agent application roller is connected with the forme cylinder 64.

The printing groups 48, 49, 51, 52, fixedly arranged between the supports 40, 42, as well as the printing groups 58, 59, 61, 62, arranged on top of each other between the supports 41, 42 in the displaceable frame element 65, are each arranged with their transfer cylinders 63 facing each other, so that a web 68 or 69 can be imprinted on both sides. As a result, the printing group 48 together with 58, 49 together with 59, 51 together with 61, and 52 together with 62 each comprise a bridge printing unit, or a print unit in bridge construction.

In this case the right printing group 58, 59, 61, 62 is arranged in the displaceable frame element 65 in such a way that it can be displaced relative to the left printing group 48, 49, 51, 52 horizontally in an axis-parallel direction of the axes of rotation of the cylinders 63, 64. To make this function clear, the left and the right frame elements 55, 65 are represented in FIGS. 6 and 7 in a plan view from above. The representations in FIGS. 6 and 7 are purely schematic, with all details not required for understanding the function having been left off. The left and the right frame elements 55, 65 are represented in the operating state in FIG. 6, in which they are locked together. Following unlocking, the left frame element 65 can be laterally displaced in an axis-parallel direction in respect to the axes of rotation of the cylinders 63, 64, as indicated by the movement arrow 71. Rails 72, 73 are provided for this purpose between the supports 40, 41, 42, 44, on which rollers 53, 54 are seated.

In addition, the right printing groups 58, 59, 61, 62 can be displaced relative to the printing groups 48, 49, 51, 52 in the direction of the axes of rotation of the cylinders 63, 64.

As represented in FIG. 7, the right frame element 65 can be displaced laterally outward, i.e. in the embodiment represented toward the right, until the right and left printing groups 48, 49, 51, 52 and 58, 59, 61, 62 are completely separated from each other, and therefore are easily accessible to the operators for service or maintenance work from the work platforms arranged in the areas 74 or 76. For example, the displaceable right frame element 65 can be actuated by means of two reciprocally acting work cylinders, for example hydraulic cylinders. However, other types of driving are of course also conceivable, for example by means of electric motors. For example, guide strips known from EP 0 749 369 B1, can be used for guiding the right frame element 65. For achieving a high degree of exact fit in the operating position of the displaceable frame element 65 it is possible to provide several pins, which extend past the closing edge, on the frame element 65, which can be brought into engagement with correspondingly arranged blind bores on the fixed-in-place left frame element 55.

In the operating position (FIG. 5), the displaceable frame element 65 is secured against inadvertent displacement by means of a mechanically operating locking element 77. The locking element 77 consists of a threaded bushing, seated fixed in place on the frame, which in the course of closing forms a positive connection with a threaded spindle, seated fixed in place on the frame element 55. In the course of this the threaded spindle is moved in the direction of the left frame 55 by means of a motor-driven threaded bushing.

During a stoppage it is possible for the operators to manually change the printing plates on the forme cylinders 64 of the left and right printing groups 48, 49, 51, 52 or 58, 59, 61, 62. For this purpose the frame elements 55, 65 must be moved far enough apart, so that the appropriate forme cylinders 64 are sufficiently accessible. Alternatively to this it is also possible to change the printing plates on the forme cylinders 64 by means of a printing plate changing device 78, which is assigned to each printing group 48, 49, 51, 52 or 58, 59, 61, 62. For example the printing plate changing device 78 can be embodied in the same way as the printing plate changing device described in EP 0 749 369 B1.

The driving of the individual printing groups 48, 49, 51, 52 or 58, 59, 61, 62 can be provided via a vertical shaft, or by means of individual drive motors assigned to the individual cylinders. A suitable drive concept is described in EP 0 749 369B1, for example.

List of Reference Numerals

01 Printing group, V-printing group

02 Printing group, W-printing group

03 Forme cylinder

04 Forme cylinder

05 -

06 Forme cylinder

07 Forme cylinder

08 Transfer cylinder

09 Transfer cylinder

10 -

11 Transfer cylinder

12 Transfer cylinder

13 Counter-pressure cylinder

14 Counter-pressure cylinder

15 -

16 Lateral frame

17 Lateral frame

18 Ink unit

19 Ink unit

20 -

21 Ink unit

22 Ink unit

23 Dampening unit

24 Dampening unit

25 -

26 Dampening unit

27 Dampening unit

28 Transverse support

29 Transverse support

30 -

31 Movement arrow

32 Movement arrow

33 Area, work platform

34 Area, work platform

35 to 39 -

40 Support, upper

41 Support, upper

42 Support, lower

43 -

44 Support, lower

45 -

46 Lateral frame, left

47 Lateral frame, left

48 Printing group, left

49 Printing group, left

50 -

51 Printing group, left

52 Printing group, left

53 Roller

54 Roller

55 Frame element, left

56 Lateral frame, right

57 Lateral frame, right

58 Printing group, right

59 Print group, right

60 -

61 Printing group, right

62 Printing group, right

63 Transfer cylinder

64 Forme cylinder

65 Frame element, right

66 Dampening unit

67 Ink unit

68 Web

69 Web

70 -

71 Movement

72 Rail

73 Rail

74 Area

75 -

76 Area

77 Locking element

78 Printing plate changing device

1. Printing groups (01, 02, 48, 49, 51, 52, 58, 59, 61, 61) of an offset rotary printing press, respectively having at least one forme cylinder (03, 04, 06, 07, 64), at least one transfer cylinder (08, 09, 11, 12, 63) and at least one ink unit (18, 19, 21, 22, 67), wherein two of these printing groups (01, 02, 48, 49, 51, 52, 58, 59, 61, 61) are arranged opposite each other, wherein the printing groups (01, 02) are arranged so that their distance relative to each other can be changed transversely in respect to the axes of rotation of the cylinders (03, 04, 06, 07, 08, 09, 11, 12, 63, 64), characterized in that the arrangement of the printing groups (01, 02, 48, 49, 51, 52, 58, 59, 61, 61) in relation to each other can be changed in an approximately axis-parallel direction (32, 71) of the axes of rotation of the cylinders (03, 04, 06, 07, 08, 09, 11, 12, 63, 64).

2. Printing groups (48, 49, 51, 52, 58, 59, 61, 61) of an offset rotary printing press, respectively having at least one forme cylinder (03, 04, 06, 07, 64), at least one transfer cylinder (08, 09, 11, 12, 63) and at least one ink unit (18, 19, 21, 22, 67), wherein two of these printing groups (48, 49, 51, 52, 58, 59, 61, 61) are arranged opposite each other, and respectively two printing groups (48, 49, 51, 52, 58, 59, 61, 61) are embodied in a so-called bridge construction as bridge units with respectively two ink units (67), respectively two forme cylinders (64) and respectively two transfer cylinders (63), and wherein the transfer cylinders (63) are oriented toward each other, characterized in that the arrangement of at least one of the printing groups (58, 59, 61, 62) per bridge unit can be changed in relation to the second printing groups (48, 49, 51, 52) in the direction (32) of the axes of rotation of the cylinders (63, 64).

3. The printing groups in accordance with claim 2, characterized in that the printing groups (01, 02) are arranged so their distance from each other can be changed.

4. The printing groups in accordance with claims 1 or 2, characterized in that one of the printing groups (01, 48, 49, 51, 52) is arranged fixed in place.

5. The printing groups in accordance with claims 1 or 2, characterized in that both printing groups (01, 02, 48, 49, 51, 52, 58, 59, 61, 62) are arranged so they can be locked together in the operating state.

6. The printing groups in accordance with one of claims 1 or 2, characterized in that at least two pairs of these printing groups (01, 02, 48, 49, 51, 52, 58, 59, 61, 62) are arranged on top of each other.

7. The printing groups in accordance with claim 6, characterized in that at least one printing group (01, 02) is fastened on a support element.

8. The printing groups in accordance with claim 7, characterized in that the support element has transverse supports (28, 29) and vertical supports.

9. The printing groups in accordance with claim 7 or 8, characterized in that at least one printing group (02) is arranged to be displaceable relative to the support element.

10. The printing groups in accordance with claim 8, characterized in that a transverse support (28, 29) is arranged between the upper and lower printing groups (01, 02, 48, 49, 51, 52, 58, 59, 61, 62).

11. The printing groups in accordance with claim 1 or 2, characterized in that the printing groups (01, 02, 48, 49, 51, 52, 58, 59, 61, 62) which are located opposite each other are arranged in separable frame elements (55, 65), wherein the arrangement of the frame elements (55, 56) relative to each other can be changed at least approximately in the axis-parallel direction (71) of the axes of rotation of the cylinder (63, 64).

12. The printing groups in accordance with claim 11, characterized in that both frame elements (55, 56) can be placed into a horizontal distance.

13. The printing groups in accordance with claim 12, characterized in that one frame element (55) is arranged fixed in place and that one frame element (56) is seated so it is displaceable in relation to it.

14. The printing groups in accordance with claim 13, characterized in that the displaceable frame element (65) is seated on rollers (53, 54) in a frame.

15. The printing groups in accordance with claim 12, characterized in that both frame elements (65, 66) are arranged so that they can be locked together in the operating state.

16. The printing groups in accordance with claim 1, characterized in that one printing group (01, 02) has respectively two forme cylinders (03, 04, 06, 07), two transfer cylinders (08, 09, 11, 12) and a counter-pressure cylinder (13, 14).

17. The printing groups in accordance with claim 16, characterized in that a V-printing group (01) and a W-printing group (02) are arranged opposite each other.

18. The printing groups in accordance with claim 17, characterized in that the V-printing group (01) is arranged fixed in place.

19. The printing groups in accordance with one of claims 16 to 18, characterized in that the printing groups (01, 02) can be coupled together.

20. The printing groups in accordance with claim 19, characterized in that the printing groups (01, 02) are arranged so they imprint one or several webs of material in the coupled, as well as the uncoupled state.

21. The printing groups in accordance with one of claims 16 to 20, characterized in that four transfer cylinders (08, 09, 11, 12) can be placed against a single counter-pressure cylinder (13).

22. The printing groups in accordance with claim 1, characterized in that respectively two printing groups (48, 58, 49, 59, 51, 61, 52, 62) are embodied in a so-called bridge construction as a bridge unit with respectively two ink units (67), respectively two forme cylinders (64) and respectively two transfer cylinders (63), and wherein the transfer cylinders (63) are oriented toward each other.

23. The printing groups in accordance with claim 22, characterized in that at least two bridge units are arranged on top of each other.
